(19) United States
(12) Patent Application Publication
(10) Pub. No.: US 2026/0193024 A1
(43) Pub. Date: Jul. 9, 2026

(54) SYSTEM FOR RECYCLING ELECTRONIC CIGARETTE AND METHOD OF USE

(71) Applicants: PENG LU, SURREY (CA); RUIBIN LU, SURREY (CA)

(72) Inventors: PENG LU, SURREY (CA); RUIBIN LU, SURREY (CA)

(21) Appl. No.: 19/013,179

(22) Filed: Jan. 8, 2025

(51) Int. Cl. B65F 1/14

(52) U.S. Cl. CPC B65F 1/14; B65F 2210/124; B65F 2210/128; B65F 2210/168; B65F 2210/17

(57) ABSTRACT

A system and method for recycling used electronic cigarettes is provided. The system includes a housing for receiving used electronic cigarettes, a smoke and fire detector, a fire extinguishing device, an identifier for determining the type and/or brand of electronic cigarette, and a counter for counting the number of disposed cigarettes. The system also includes a CPU for controlling the fire extinguishing device, a server for data analysis, and a mobile application for managing the system. Additional features include a display screen, a rewards dispenser, a solar panel for power generation, and a location device. The method involves identifying and counting the disposed electronic cigarettes, detecting and extinguishing smoke or fire, analyzing data, providing rewards to users, displaying information, determining the system's location, sending alerts to management, generating power using a solar panel, wirelessly transmitting data to a server, and managing the system through a mobile application.

### TECHNICAL FIELD

This disclosure relates to garbage recycling, and in particular recycling of electronic cigarettes, also known as e-cigarettes or vape.

### BACKGROUND

Electronic cigarettes are becoming increasingly popular with the public, and there is a trend of replacing traditional cigarettes. The sale of e-cigarettes is growing at a rate of more than 10% every year. The annual consumption of e-cigarettes in the North American market reaches more than 500 million pieces.

E-cigarettes generally include lithium-ion battery, PCBA (circuit board), display screen, shell that is made of metal and/or plastic, plastic head including nozzle and bottom cover, wires, LED lights, pulp, water inlet pipe made of stainless steel and other materials. If the disposal of used e-cigarettes is not taken with care, the materials of e-cigarettes will cause serious harm to natural environment such as water sources and soil.

Currently, e-cigarette manufacturers, brand operators, and terminal wholesalers do not have a coordinated method to recycle used e-cigarettes, leaving consumers dispose the used e-cigarettes as they wish regardless of the possible environmental harm.

Further, there is no suitable hardware and software equipment to be put into various places to help recycle e-cigarettes.

Therefore, it is desirable to have a system to recycle e-cigarettes and encourage consumers to assist in recycling e-cigarettes as much as possible, which can reduce environmental pollution and is also conducive to resource recycling.

### SUMMARY

The present disclosure relates to a system and method for recycling used electronic cigarettes (e-cigarettes). The system includes a housing made of fire-resistant material for receiving the used e-cigarettes. A smoke and fire detector is installed in the housing to determine the presence of smoke or fire, and a fire extinguishing device is operatively connected to the detector to extinguish any detected smoke or fire. An identifier, such as a barcode or QR code scanner, is used to determine a characteristic of the e-cigarette disposed, for example, the type or brand of the e-cigarettes. The system also includes a counter keeps track of the number of e-cigarettes received in the housing.

The system is controlled by a central processing unit (CPU) that communicates with a server for data analysis and a mobile application for system management. The housing also includes a display screen for showing information about the disposed e-cigarettes and advertisements, a dispenser for providing rewards to users, a solar panel for generating power, and a location device for determining the system's location.

The method involves providing the recycling system, identifying and counting the disposed e-cigarettes, detecting and extinguishing any smoke or fire, analyzing data, providing rewards to users, displaying information, determining the system's location, sending alerts to management when a predetermined number of e-cigarettes have been received in the housing, generating power using the solar panel, wirelessly transmitting data to the server, and managing the system through the mobile application.

This disclosure aims to encourage proper disposal and recycling of used e-cigarettes, reducing environmental pollution and promoting resource recycling.

### BRIEF DESCRIPTION OF FIGURES

The disclosure will be explained in more detail in the following with reference to embodiments and to the drawing in which are shown:

FIG. 1 shows one embodiment of the system of the disclosure.

FIG. 2 shows the system 100 including the server and mobile application and the connection therebetween.

### DETAILED DESCRIPTION

In the following description, numerous specific details are set forth in order to provide a more thorough description of the present disclosure. It will be apparent, however, to one skilled in the art, that the present disclosure may be practiced without these specific details. Other embodiments of the disclosure will readily suggest themselves to such skilled persons having the benefit of this disclosure. In some instances, well-known features have not been described in detail so as not to obscure the disclosure.

As used herein, the following terms and variations thereof have the meanings given below, unless a different meaning is clearly intended by the contest in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers ingredients or steps.

The term “connected,” “attached to” or similar expression may indicate that the elements are directly connected to each other or connected through other components.

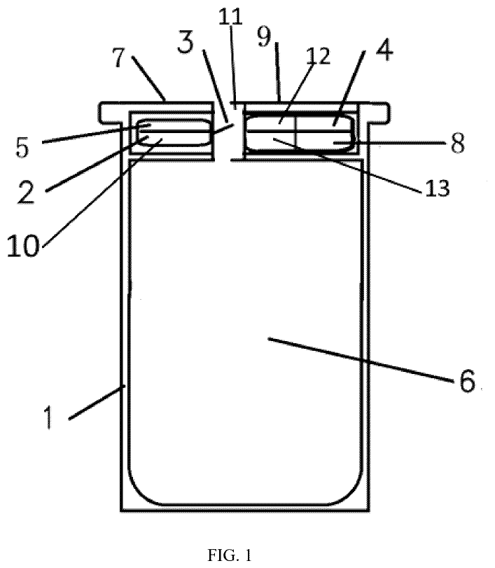

Referring first to FIG. 1, which shows one embodiment of the recycling system of the disclosure.

The system 100 includes a housing 1, which may be made of fire-resistant material. The housing 1 may house a one-time use recycling bag to receive the used e-cigarettes. The bag can be removed and replaced when needed. The bag may be made of heat-and fire-resistant material.

The system 100 includes a smoke and fire detector 2 that is configured to detect smoke and fire in the housing 1. The detector 2 may be wirelessly connected to a device, for example, a mobile phone, such that an application on the mobile phone can send an alert to the management of the system 100. The wireless connection may be by wireless internet, for example, WIFI or cellular data, or short-range wireless communication such as Bluetooth, or mobile internet.

The housing 1 includes an opening 11. An identifier 9 and counter 3 is disposed in the opening 11 to identify whether the item disposed is an e-cigarette. If the item disposed is an e-cigarette, the characteristics of the e-cigarette, for example, the type and/or brand of e-cigarette. The identifier 9 and counter 3 also counts the number of e-cigarettes disposed into the housing 1 through the opening 11.

The identifier 9 may include a barcode and/or quick-response (QR) code scanner for identifying the characteristics of the e-cigarette, for example, the type and/or brand of the e-cigarette. The identifier 9 may also be based on appearance recognition, electronic induction, product image recognition assisted by artificial intelligence (AI), or other appropriate principles, which will be able to identify other characteristics of the e-cigarette, for example, the length, thickness, material composition, shape, or temperature of the e-cigarette.

The identifier 9 and counter 3 may be wirelessly connected to a mobile device, for example, a mobile phone, such that an application on the mobile phone can receive the information about the disposed e-cigarettes and alert when the number of the e-cigarettes counted reaches a predetermined number.

The system 100 also includes a central processing unit (CPU) 4, which is operatively connected to the smoke and fire detector 2. The CPU 4 processes relevant information such as the type, brand, and number of e-cigarettes disposed into the housing 1 through the opening 11. The CPU 4 is operatively connected to the smoke and fire detector 2, identifier 9, and counter 3.

The CPU 4 may be wirelessly connected to a device, for example, a mobile phone, such that an application on the mobile phone can send an alert to the management of the system 100. The wireless connection may be by wireless internet or short-range wireless communication such as Bluetooth, or mobile internet. The CPU 4 may be used for data management, network data sending, positioning, voice prompts or advertising, alarms, etc.

The system 100 includes a fire extinguishing device 13, which is operatively connected to the CPU 4. When smoke or fire is detected by the smoke and fire detector 2, the information is forwarded to the CPU 4, which then determines whether it is necessary to extinguish the smoke or fire, for example, if the smoke or fire is detected, or the temperature in the housing is above a predetermined value. If the CPU 4 determines that the smoke or fire needs to be extinguished, the CPU 4 activates the fire extinguishing device 13 to prevent fire or explosion.

A power supply 5 is provided to supply electricity to the system 100, for example, the smoke and fire detector 2, the e-cigarette identifier and counter 3, and the CPU 4. The power supply 5 may be utility power or a battery. The battery may be replaceable and/or rechargeable. The battery enables the system 100 to operate normally, for example, when the municipal power supply is cut off. The utility power may be Alternating current (AC) power. The battery may be charged by the utility power.

An output 6 is disposed on the housing 1. The output 6 may be electronic display or a printer. The display 6 may be controlled by the CPU 4 to display various content in different scenarios. For example, the display 6 may be programmed to display advertisements, for example, charitable or commercial, when the system 100 is not in use by a user. The display 6 may be programmed to display the type, brand and/or number of the e-cigarettes when in use to give feedback to the user who is disposing the e-cigarettes into the system 100. There may be multiple displays to display different contents simultaneously. The display 6 may include a speaker. The display 6 may be configured to provide visual and audible encouragement to the user, for example, by praising and thanking consumers for valuing environmental protection. or voice/audio brand advertising. The display 6 may also be configured to provide audible advertisement.

A solar panel 7 is provided in the system 100 to generate electricity to supply electricity to the system 100 and/or to charge the battery of power supply 5. The solar panel 7 and battery 5 may cooperate so that the system 100 operates continuously without municipal power supply.

The system 100 includes a dispenser 8. When the system 100 is configured to provide cash reward, the dispenser 8 will provide cash to the user according to the type, brand, or number of e-cigarettes.

The system 100 includes an identifier 9, which may be a bar code and/or quick-response (QR) code scanner. The output 6 may be a printer or a display. When a cashless reward is issued, a bar code or a QR code may be issued through the printer or the display for the user to scan and claim the reward.

The system 100 includes a wireless communication module 10 to enable the modules of system 100 to wireless communicate with other devices.

The system 100 includes a location device 12 that is operatively connected to the CPU 4. The location device is able to determine the location of the housing 1, for example, by GPS, Glonass, Galileo, or Beidou. This information may be processed by the CPU 4 and forwarded to the server.

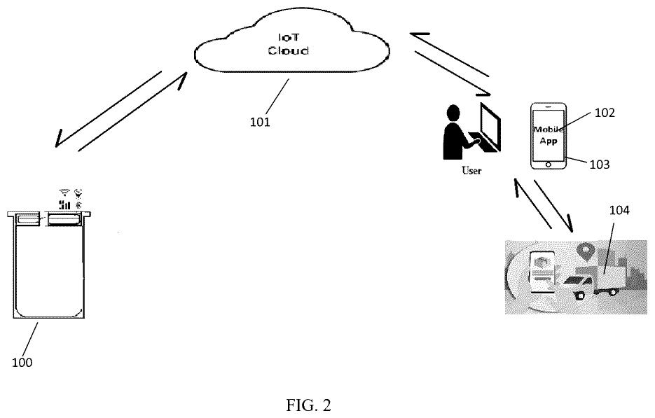

Reference is now made to FIG. 2.

The system 100 is wirelessly connected to a server 101, which is configured to analyze the management data and the location of the merchant where the housing 1 is installed. The server may determine whether it is necessary to send personnel to the to pick up and receive the used e-cigarettes disposed in system 100, for example, when the number of used e-cigarettes in the housing 1 is above a predetermined value, or the volume of used e-cigarettes in the housing 1 is above a predetermined value. When the server determines that pick up is needed, for example, the number of e-cigarettes is more than a predetermined value, the server sends an alert to the personnel 104 to pick up the used e-cigarettes disposed in the system 100.

The system 100 also includes a mobile application 102 that is installed on a mobile device 103, such as a terminal device or a mobile communication device, for example, a mobile phone. The application is configured to manage and receive the information sent by the system 100 or the server 101, for example, the quantity of e-cigarettes that need to be collected, the temperature in the housing 1, management of fire alarm, or manage the setting of the housing 1. The recycling management of the system 100 may send data to the housing 1 for access management, for example, testing whether the equipment is working properly, and setting up the display screen for various contents such as charitable and commercial advertisements. In some embodiments, the mobile application 102 alerts the personnel to collect the used e-cigarettes when the number of used electronic cigarettes disposed in the system exceeds a predetermined value.

A method is provided for using the system 100 to recycle used e-cigarettes that encourages responsible disposal of used e-cigarettes. The method encourages the users to dispose used e-cigarettes into the dedicated recycling system 100 by providing incentives to the users to recycle the used e-cigarettes.

The method may also help establish a commercial brand or the environmental image of the government, non-profit organization, and may also promote the sales of commercial brands.

As a result, the method facilitates recycling of e-cigarettes and protecting the environment.

In some embodiments, cash reward is provided to the user who disposes the used e-cigarettes into the system 100. Every time a user disposes a used e-cigarette into the system 100, a cash reward is provided through the dispenser 8.

In some embodiments, a coupon for receiving a discount when purchasing a new e-cigarette or other products is provided when the user dispose a used e-cigarette into the system 100. The coupon may be provided through the dispenser 8.

In some embodiments, a points reward system is used to reward the user who dispose the used e-cigarette into the system 100.

In some embodiments, the system 100 provides encouragement to the users who dispose the used e-cigarettes into the system 100. For example, when the use disposes a used e-cigarette into the system 100, the system provides audio and/or visual greetings to thank the user for caring for the environment. In some embodiments, the system 100 displays advertisements for the brand of the disposed used e-cigarettes.

The cost for the cash or other incentives may be borne by a retailer, brand operators, manufacturers, government, or non-profit organizations.

The disposed e-cigarettes may be collected by retailers, wholesalers, brand operators, manufacturers, government, non-profit organizations, or out-sourced professional recycling companies. Collected e-cigarettes may be sent to a company to dismantle and recycle the components.

Although the present disclosure has been described in relation to particular embodiments thereof, many other variations and modifications and other uses will become apparent to those skilled in the art. It is preferred, therefore, that the present disclosure be limited not by the specific disclosure herein.

1. A system for recycling used electronic cigarettes, comprising:
a housing for receiving the used electronic cigarettes;
a smoke and fire detector for determining whether smoke or fire is present in the housing;
a fire extinguishing device operatively connected to the smoke and fire detector, and configured to extinguish smoke or fire in the housing;
an identifier for identifying a characteristic of a used electronic cigarette received in the housing, wherein the characteristic is a type or brand of the used electronic cigarette, and wherein the identifier includes at least one of a barcode scanner, a QR code scanner, appearance recognition, electronic induction, or product image recognition assisted by artificial intelligence;
a replaceable one-time use recycling bag made of heat-and fire-resistant material, disposed in the housing for collecting the used electronic cigarettes;
a counter for counting a number of the used electronic cigarettes received in the housing; and
a power supply.

2. The system of claim 1, further comprising:
a central processing unit (CPU) operatively connected to the smoke and fire detector and the fire extinguishing device;
wherein
the CPU is configured to determine, based on information received from the smoke and fire detector, whether to activate the fire extinguishing device; and
the CPU activates the fire extinguishing device if the CPU determines to activate the fire extinguishing device.

3. The system of claim 2, further comprising:
a location device operatively connected to the CPU and configured to determine a location of the housing.

4. The system of claim 2, further comprising:
a server wirelessly connected to the CPU;
wherein the server is configured to analyze data and information received from the CPU.

5. The system of claim 4, further comprising:
a mobile application provided on a mobile device, the mobile device wirelessly connected to the server;
wherein the mobile application is configured to manage and receive information sent by the system or the server.

6. The system of claim 5, wherein the mobile application is configured to alert personnel to collect the used electronic cigarettes when the number of used electronic cigarettes exceeds a predetermined value.

7. The system of claim 1, further comprising:
a display screen configured to display information about the used electronic cigarettes received in the housing and advertisements.

8. The system of claim 7, wherein the display screen includes a speaker, which is configured to provide audible encouragement, or to provide audible advertisement.

9. The system of claim 1, further comprising:
a dispenser configured to provide rewards to users for disposing electronic cigarettes.

10. The system of claim 1, wherein
the power supply is a battery, utility power, or a solar panel.

11. (canceled)

12. (canceled)

13. (canceled)

14. A method for recycling used electronic cigarettes, comprising:
providing a recycling system with a housing, a replaceable one-time use recycling bag made of heat-and fire-resistant material, disposed in the housing for receiving the used electronic cigarettes;
powering the recycling system with a power supply identifying a characteristic of a used electronic cigarette received in the housing, wherein the characteristic is a type or brand of the used electronic cigarette, and wherein the identifying is by at least one of a barcode scanner, a QR code scanner, appearance recognition, electronic induction, or product image recognition assisted by artificial intelligence;
counting a number of the used electronic cigarettes received in the housing;
detecting presence of smoke or fire in the housing; and
extinguishing the smoke or fire in the housing if detected.

15. The method of claim 14, further comprising:
analyzing data and information related to the used electronic cigarettes received in the housing.

16. The method of claim 14, further comprising:
providing rewards to users for disposing electronic cigarettes in the recycling system.

17. The method of claim 16, wherein the rewards include at least one of cash, coupon, or points.

18. The method of claim 14, further comprising:
displaying information about the received used electronic cigarettes and/or advertisements on a display screen.

19. The method of claim 14, further comprising:
determining a location of the recycling system.

20. The method of claim 14, further comprising:
sending alerts to personnel when a predetermined number of used electronic cigarettes have been disposed in the housing.

21. The method of claim 14, wherein
the power supply is a battery, utility power, or a solar panel.

22. The method of claim 14, further comprising:
wirelessly transmitting data about the received used electronic cigarettes to a server for analysis.

23. The method of claim 22, further comprising:
managing and receiving information about the recycling system through a mobile application on a mobile device.
